(19) United States
(12) Patent Application Publication
(10) Pub. No.: US 2013/0200068 A1
(43) Pub. Date: Aug. 8, 2013

(54) IRON-NICKEL-CHROMIUM-SILICON ALLOY

(71) Applicant: OUTOKUMPU VDM GMBH, WERDOHL (DE)

(72) Inventors: HEIKE HATTENDORF, WERDOHL (DE); JUERGEN WEBELSIEP, WITTEN (DE)

(73) Assignee: OUTOKUMPU VDM GMBH, WERDOHL (DE)

(21) Appl. No.: 13/837,325

(22) Filed: Mar. 15, 2013

Related U.S. Application Data
(62) Division of application No. 12/646,756, filed on Dec. 23, 2009.
Application No. 12/646,756 is a continuation-in-part of application No. PCT/DE2008/000965, filed on Jun. 12, 2008.

(30) Foreign Application Priority Data
Jun. 26, 2007 (DE) 10 2007 029 400.1

(51) Int. Cl. C22C 19/05; H05B 3/12

(52) U.S. Cl. CPC C22C 19/058; H05B 3/12
USPC 219/553; 420/443

(57) ABSTRACT

The invention relates to an iron-nickel-chromium-silicon alloy comprising (in wt.-%) 19 to 34% or 42 to 87% nickel, 12 to 26% chromium, 0.75 to 2.5% silicon, and additives of 0.05% to 1% Al, 0.01 to 1% Mn, 0.01 to 0.26% lanthanum, 0.0005 to 0.05% magnesium, 0.04 to 0.14% carbon, 0.02 to 0.14% nitrogen, and further comprising 0.0005 to 0.07% Ca, 0.002 to 0.020% P, a maximum of 0.01% sulfur, a maximum of 0.005% B, the remainder comprising iron and the usual process-related impurities

### REFERENCE TO RELATED APPLICATIONS

The present application is a divisional of copending U.S. application Ser. No. 12/646,756, filed Dec. 23, 2009, which is a continuation-in-part of International Application PCT/DE2008/000965 filed Jun. 12, 2008. The disclosures of these references are incorporated herein by reference.

### BACKGROUND OF THE INVENTION

The invention relates to iron-nickel-chromium-silicon alloys having a longer service life and enhanced dimensional stability.

Austenitic iron-nickel-chromium-silicon alloys having different nickel, chromium, and silicon contents have been used for some time as heat conductors in the temperature range up to 1100° C. This alloy group is standardized in DIN 17470 (Table 1) and ASTM B344-01 (Table 2) for use as heat conductor alloys. There are a number of commercially available alloys, listed in Table 3, for this standard.

The sharp increase in the price of nickel in recent years has resulted in a desire to employ heat conductor alloys that have the lowest possible nickel content and to significantly increase the service life of the alloys employed. This makes it possible for the manufacturer of heating elements either to change to an alloy that has a lower nickel content or to use greater durability to justify a higher price to the customer.

In general it should be noted that the service life and usage temperature for the alloys listed in Tables 1 and 2 increase as the nickel content climbs. All of these alloys form a layer of chromium oxide (Cr₂O3) having a layer of SiO2 thereunder that is more or less closed. Small additions of elements that have high affinity for oxygen such as Ce, Zr, Th, Ca, Ta (Pfeifer/Thomas, Zunderfeste Legierungen [Non-Scaling Alloys] (2nd Edition, Springer Verlag 1963, pages 258 and 259) increase service life, wherein the effect of only one single element with affinity for oxygen was investigated in this case, but no information was provided about the effect of a combination of such elements. When the heat conductor is employed, the chromium content is slowly depleted for building up the protective layer. Therefore a higher chromium content increases service life since a higher content of chromium, the element that forms the protective layer, delays the point in time at which the Cr content drops below the critical limit and oxides other than Cr₂O₃ form, which are e.g. iron-containing ferrous oxides.

Known from EP-A 0 531 775 is a heat-resistant hot-formable austenitic nickel alloy having the following composition (in wt. %):

| | |
|---|---|
| C | 0.05-0.15% |
| Si | 2.5-3.0% |
| Mn | 0.2-0.5% |
| P | Max. 0.015% |
| S | Max. 0.005% |
| Cr | 25-30% |
| Fe | 20-27% |
| Al | 0.05-0.15% |
| Cr | 0.001-0.005% |
| SE | 0.05-0.15% |
| N | 0.05-0.20% |

and the remainder Ni and process-related impurities.

EP-A 0 386 730 describes a nickel-chromium-iron alloy having very good oxidation resistance and thermal strength, these being desired for advanced heat conductor applications that proceed from the known heat conductor alloy NiCr6015 and in which significant improvements in the usage properties could be attained using modifications to the composition that were matched to one another. The alloy is distinguished from the known NiCr6015 material especially in that the rare earth metals are replaced by yttrium, in that it also includes zirconium and titanium, and in that the nitrogen content is matched to the content of zirconium and titanium in a special manner.

WO-A 2005/031018 describes an austenitic Fe—Cr—Ni alloy for use in the high temperature range that essentially has the following chemical composition (in wt. %):

| | |
|---|---|
| Ni | 38-48% |
| Cr | 18-24% |
| Si | 1.0-1.9% |
| C | <0.1% |
| Fe | Remainder |

With free-hanging heating elements, in addition to the requirement for a long service life there is also the requirement for good dimensional stability at the application temperature. If the coil sags too much during operation, the spacing between the windings becomes uneven, resulting in uneven temperature distribution and shortening service life. To compensate for this, more support points would be necessary for the heating coil, which increases costs. This means that heat conductor materials must have adequate dimensional stability and creep resistance.

Apart from dislocation creep, the creep mechanisms that have a negative impact on dimensional stability in the application temperature range (dislocation creep, grain boundary slip, and diffusion creep) are all influenced by a large grain size to have greater creep resistance. Displacement creep is not solely a function of grain size. Producing a wire having a larger grain size increases creep resistance and thus dimensional stability. In any considerations grain size should therefore be included as a factor that has significant influence.

Also important for a heat conductor material is the greatest possible specific electrical resistance and the lowest possible change in the ratio of heat resistance/cold resistance to temperature (temperature coefficient ct).

### SUMMARY OF THE INVENTION

The underlying object of the invention is to design alloys with contents of nickel, chromium, and Si similar to the alloys in accordance with the prior art in Tables 1 and 2, but that have
a) significantly improved oxidation resistance and concomitant long service life;
b) significantly improved dimensional stability at the application temperature;
c) high specific electrical resistance in conjunction with the least possible change in the ratio of heat resistance/cold resistance to temperature (temperature coefficient ct).

This object is attained using an iron-nickel-chromium-silicon alloy having (in wt. %) 19 to 34% or 42 to 87% nickel, 12 to 26% chromium, 0.75 to 2.5% silicon, and additions of 0.05 to 1% Al, 0.01 to 1% Mn, 0.01 to 0.26% lanthanum, 0.0005 to 0.05% magnesium, 0.04 to 0.14% carbon, 0.02 to 0.14% nitrogen, moreover including 0.0005 to 0.07% Ca, 0.002 to 0.020% P, max. 0.01% sulfur, max. 0.005% B, the remainder iron and the usual process-related impurities.

Due to their special composition, these alloys have a longer service life than the alloys in accordance with the prior art that have comparable nickel and chromium contents. In addition, it is possible to attain enhanced dimensional stability and less sagging than the alloys in accordance with the prior art.

### BRIEF DESCRIPTION OF THE DRAWINGS

FIG. 1 is a plot of relative burn time (tb) as a function of La content, with adjustments for the effects of the contents of Ni, Cr, and Si using multiple linear regression analysis;

FIG. 2 is a plot of sagging of coils as a function of N content, with adjustments for the effects of the contents of Ni, Cr, Si, and C using multiple linear regression analysis; and

FIG. 3 is a plot of sagging of coils as a function of C content, with adjustments for the effects of the contents of Ni, Cr, Si, and N using multiple linear regression analysis.

### DETAILED DESCRIPTION OF THE INVENTION

The range for the element nickel is either between 19 to 34% or 42 to 87%, the following nickel contents being possible depending on use and being adjusted in the alloy regardless of the use.

Preferred Ni ranges between 19 and 34% are provided as follows:
19 to 25%
19 to 22%
23 to 25%
25 to 34%
25 to 28%
28 to 31%
31 to 34%

Preferred Ni ranges between 42 and 87% are provided as follows:
42 to 44%
44 to 52%
44 to 48%
48 to 52%
52 to 57%
57 to 65%
57 to 61%
61 to 65%
65 to 75%
65 to 70%
70 to 75%
75 to 83%
75 to 79%
79 to 83%,

The chromium content is between 12 and 26%, it being possible for there to be chromium content as follows, again depending on the area in which the alloy will be employed:
14 to 26%
14 to 18%
18 to 21%
20 to 26%
21 to 24%
20 to 23%
23 to 26%.

The silicon content is between 0.75 and 2.5%, it being possible to adjust defined contents within the range depending on the area of application:
1.0-2.5%
1.5-2.5%
1.0-1.5%
1.5-2.0%
1.7-2.5%
1.2-1.7%
1.7-2.2%
2.0-2.5%.

The element aluminum is provided as an additive, specifically in contents of 0.05 to 1%. It can preferably be adjusted in the alloy as follows:
0.1-0.7%.

The same applies to the element manganese, which is added as 0.01 to 1% of the alloy. Alternatively, the following range is also possible:
0.1-0.7%.

The inventive subject matter preferably proceeds from the fact that the material properties provided in the examples are essentially adjusted with the addition of the element lanthanum in contents of 0.01 to 0.26%. In this case, as well, defined values can be adjusted in the alloy, depending on the area of application:
0.02-0.26%
0.02-0.20%
0.02-0.15%
0.04-0.15%.

This applies in the same manner for the element nitrogen, which is added in contents between 0.02 and 0.14%. Defined content can be as follows:
0.02-0.0%
0.03-0.09%
0.05-0.09%.

Carbon is added to the alloy in the same manner, in contents between 0.04 and 0.14%. Specifically content can be adjusted in the alloy as follows:
0.04-0.10%.

Magnesium is also among the added elements, in contents of 0.0005 to 0.05%. Specifically, it is possible to adjust this element in the alloy as follows:
0.001-0.05%
0.008-0.05%.

Moreover, the alloy can include calcium in contents between 0.0005 and 0.07%, especially 0.001 to 0.05% or 0.01 to 0.05%.

Moreover, the alloy can include phosphorus in contents between 0.002 and 0.020%, especially 0.005 to 0.02%.

The elements sulfur and boron can be in the alloy as follows:

| | |
|---|---|
| Sulfur | Max. 0.005% |
| Boron | Max. 0.003%. |

If the effectiveness of the reactive element lanthanum is not sufficient alone for producing the material properties described in the statement of the object, the alloy can moreover include at least one of the elements Ce; Y, Zr, Hf, Ti, with contents of 0.01 to 0.3%, wherein when needed the elements may also be defined additives,

Adding elements that have affinity for oxygen, such as preferably La and where needed Ce, Y, Zr, Hf, Ti, improves service life. These additions do this in that they are also built into the oxide layer and there block the diffusion paths for the oxygen on the grain boundaries. The quantity of the elements available for this mechanism must therefore be adjusted to the atomic weight in order to be able to compare the quantities of different elements to one another.

The potential of the effective elements (PwE) is therefore defined as

PwE=200·Σ(X_{E}/atomic weight of E)

where E is the element in question and X_{E} is the content of the element in question in percent.

As already addressed, the alloy can include 0.01 to 0.3% of one or a plurality of the elements La, Ce, Y, Zr, Hf, Ti, whereby

ΣPwE=1.43·X_{Ce}+1.49·X_{La}+2.25·X_{Y}+2.19+1.12·X_{Hf}+4.18·X_{Ti}≦0.38,

especially ≦0.36 (at 0.01 to 0.02% of the entire element), wherein PwE is the potential of the effective elements.

Alternatively, if at least one of the elements La, Ce, Y. Zr, Hf, Ti is present in contents of 0.02 to 0.10%, there is the possibility that the total PwE=1.43·X_{Ce}+1.49·X_{La}+2.25·X_{Y}+2.19·X_{zr}+1.12·X_{Hf}+4.18·X_{Ti} is less than or equal to 0.36, wherein PwE is the potential of the effective elements.

Moreover, the alloy can contain between 0.01 to 1.0% of one or a plurality of the elements Mo, W, V, Nb, Ta, Co, which can additionally be further limited as follows:
0.01 to 0.06%
0.01 to 0.2%.

Finally, there can also be the elements copper, lead, zinc, and tin in impurities in contents as follows:

| | |
|---|---|
| Cu | max. 1.0% |
| Pb | max. 0.002% |
| Zn | max. 0.002% |
| Sn | max. 0.002%. |

The inventive alloy should preferably be used for employment in electrical heat ng elements, especially in electrical heating elements that require good dimensional stability and low sagging.

However, it is also possible to use the inventive alloy in heating elements of tubular heating bodies.

Another specific application for the inventive alloy is use in furnace construction. The inventive subject matter shall be explained in greater detail using the following examples.

### EXAMPLES

As already stated in the foregoing, Tables 1 to 3 reflect the prior art.

For the alloys smelted on an industrial scale in the following examples, a commercially produced and soft annealed specimen having a 1.29 mm diameter was taken. A smaller quantity of the wire, on a laboratory scale of up to 0.4 mm, was taken for the service life test.

For heating elements, especially heat conductors in the form of wire, accelerated service life tests for comparing materials to one another are possible and usual for example with the following conditions:

The heat conductor service life test is performed on wires that have a diameter of 0.40 mm. The wire is clamped between 2 power supplies spaced 150 mm apart and is heated to 1150° C. by applying a voltage. Each heating interval to 1150° C. is performed for 2 minutes and then the power supply is interrupted for 15 seconds. The wire fails at the end of its service life in that the rest of the cross-section melts through. The burn time is the sum of the “On” times during the service life of the wire. The relative burn time tb is this figure as a percentage of the burn time for a reference lot.

For investigating dimensional stability, the sagging behavior of heating coils at the application temperature is investigated in a sagging test. The sagging of heating coils from the horizontal is determined after a certain period of time. The less sagging there is, the greater the dimensional stability or creep resistance of the material.

For this test, soft annealed wire having a diameter of 1.29 mm is wound into spirals that have an interior diameter of 14 mm. For each lot, a total of 6 heating coils are produced, each coil having 31 windings. All heating coils are brought to a uniform starting temperature of 1000° C. at the beginning of the test. The temperature is measured with a pyrometer. The test is performed at constant voltage with a switching cycle of 30 s “On”/30 s “Off”. The test concludes after 4 hours. After the heating coils have cooled, the sagging of the individual windings from the horizontal is measured and the mean of the 6 readings for the heating coils is found.

Different exemplary alloys having nickel contents of 30 to 34%, or 50 to 60% Ni, 16 to 22% Cr, 1.3 to 2.2% Si, and additions of 0.2 to 0.5% Al, 0.3 to 0.5% Mn, 0.01 to 0.09% La, 0.005 to 0.014% Mg, 0.01 to 0.065% C, 0.03 to 0.065% N, moreover including 0.001 to 0.04 Ca, 0.005 to 0.013% P, 0.0005 to 0.002% S, max 0.003 B, 0.01 to 0.08% Mo, 0.01 to 0.1% Co, 0.02 to 0.08% Nb, 0.01 to 0.06% V, 0.01 to 0.02% W, 0.01 to 0.1% Cu, the remainder iron and a PwE value of 0.09 to 0.19 were produced on an industrial scale and investigated as described in the foregoing.

The results were evaluated using multiple linear regression.

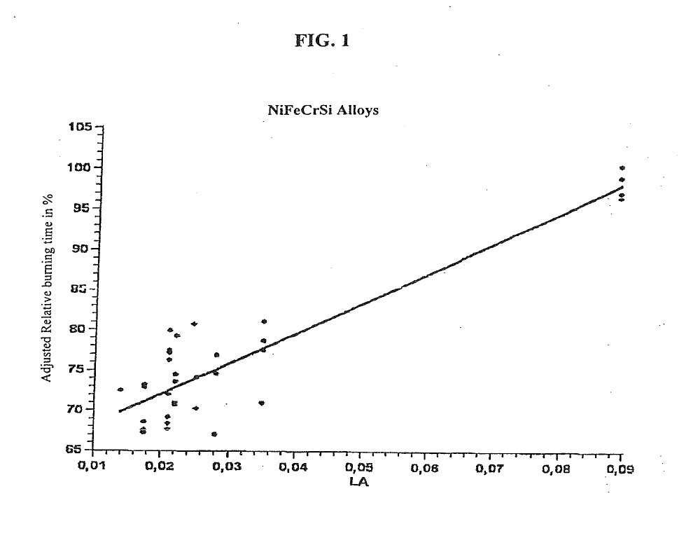

FIG. 1 depicts the relative burn time as a function of La content, adjusted for the effects of Ni, Cr, and Si content. It can be seen that the relative burn time increases sharply as La content increases. An La content of 0.04 to 0.15% is particularly advantageous.

When evaluating sagging (of the coils), only specimens having a grain size of 20 to 25 μm were included so that after this parameter no regression has to be performed.

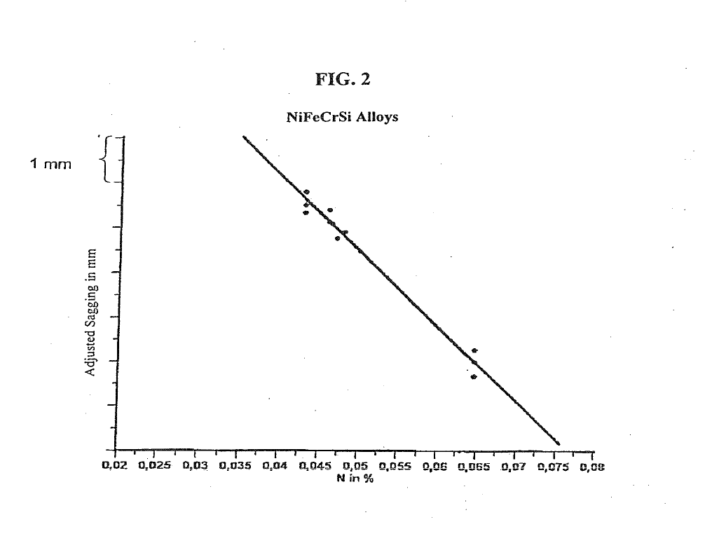

FIG. 2 depicts how sagging is a function of N content, adjusted for the effects of Ni, Cr, Si and C content. It is already evident that sagging drops sharply as N content increases. An N content of 0.03 to 0.09% is especially advantageous.

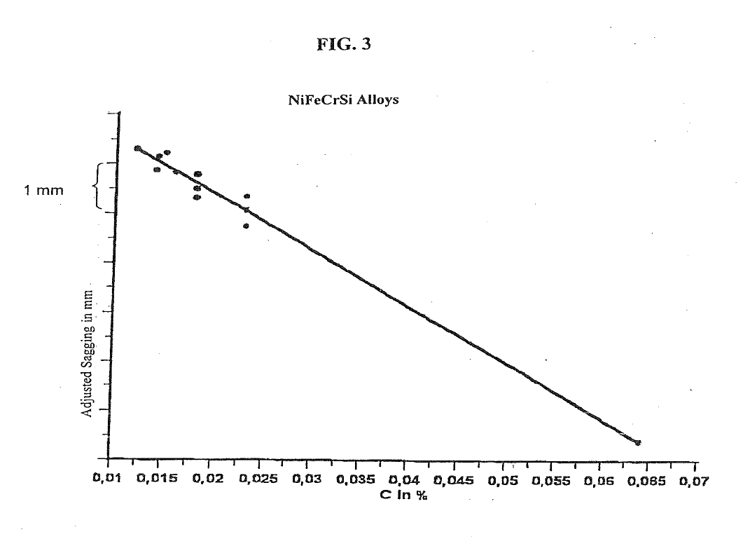

FIG. 3 indicates how sagging is a function of C content, adjusted for the effects of Ni, Cr, Si and N content. It is evident that sagging drops sharply as C content increases. C content of 0.04 to 0.10% is especially advantageous.

Alloys having a low nickel content (variant 1) are particularly cost-effective. Therefore the alloys in the range from 19% to 34% Ni are of great interest, despite the worse temperature coefficients and lower specific electrical resistances in comparison to alloys with higher nickel content. The risk of sigma phase formation, which causes the alloy to become brittle, rises increasingly at less than 19% nickel. Therefore 19% constitutes the lower limit for the nickel content.

The costs for the alloy rise with the nickel content. Therefore the upper limit for the alloys having a low nickel content should be 34% (variant 1).

The temperature coefficient increasingly improves with greater than 42% Ni. The specific electrical resistance is higher, as well. At the same time, the nickel portion compared to alloys having high nickel content is relatively low, approx. 80%. Therefore 42% is a reasonable lower limit for the alloys having a higher nickel content (variant 2).

Alloys with more than 87% no longer include enough Cr and Si to have adequate oxidation resistance. The upper limit for nickel content is therefore 87%.

Cr content that is too low means that the Cr concentration drops below the critical limit too rapidly. The lower limit for chromium is therefore 12%. Cr content that is too high has a negative impact on the alloy's processability. The upper limit for Cr should therefore be 26%.

The formation of a silicon oxide layer beneath the chromium oxide layer reduces the oxidation rate. When less than 0.75%, the silicon oxide layer has too many gaps for its full effect to be achieved. Si content that is too high has a negative effect on the alloy's processability. The upper limit for SI content is therefore 2.5%.

As stated in the foregoing, additions of elements that have affinity for oxygen improve service life. They do this in that they are included in the oxide layer and there block the diffusion paths of the oxygen on the grain boundaries. The quantity of the elements available for this mechanism must therefore be adjusted to the atomic weight in order to be able compare the quantities of different elements to one another.

The potential of the effective elements PwE is therefore defined as

PwE=200·Σ(X_{E}/atomic weight of E)

E being the element in question and X_{E} being the content of the element in question in %.

When La and Ce or SE are present, it appears that Ca and Mg are no longer effective elements.

Therefore La, Ce, Y, Zr, Hf, and Ti were used for the addition for the potential of the effective elements PwE. If there is no information about La and Ce, but due to the addition of Cer mixed metal there is only all-inclusive information about SE, Ce=0.6 SE and La=0.35 SE is assumed for calculating the PwE.

PwE=1.49·X_{La},1.43·C_{Ce}+2.25·X_{Y}+2.19·X_{zr}+1.12·X_{Hf}+4.18·X_{Ti}

A minimum content of 0.01% La is necessary to retain the effect La has of increasing oxidation resistance. The upper limit is set at 0.26%, which equals a PwE of 0.38. Greater values for PwE do not make sense in this case.

Al is required for improving the processability of the alloy. A minimum content of 0.05% is therefore necessary. A content that is too high again has a negative effect on processability. Al content is therefore limited to 1%.

A minimum content of 0.04% C is necessary for good dimensional stability and low sagging. C is limited to 0.14% because this element reduces oxidation resistance and processability.

A minimum content of 0.02% N is necessary for good dimensional stability and low sagging. N is limited to 0.14% because this element reduces oxidation resistance and processability.

A minimum content of 0.0005% Mg is necessary; it improves the processability of the material. The limit is set at 0.05% because too much Mg has proved to have a negative effect.

A minimum content of 0.0005% Ca is necessary because it enhances the processability of the material. The limit is established at 0.07% because too much CA has proved to have a negative effect.

The sulfur and boron contents should be kept as low as possible because these surfactant elements have a negative effect on oxidation resistance. Therefore max. 0.01% S and max. 0.005% B are established.

Copper is limited to max. 1% because this element reduces oxidation resistance.

Pb is limited to max. 0.002% because this element reduces oxidation resistance. The same applies to Sn.

A minimum content of 0.01% Mn is necessary for enhancing processability. Manganese is limited to 1% because this element also reduces oxidation resistance.

TABLE 1
Alloys according to DIN 17470 and 17742 (Composition of NiCr8020, NiCr7030, NiCr6015). All figures in wt. %

| | | | | | | | | | | | | ρ(μΩm) | ρ(μΩm) |
|---|---|---|---|---|---|---|---|---|---|---|---|---|---|
| | W No. | Cr | Ni + Co *) | Fe | Al | Si | Mn | C | Cu | P | S | 20° C. | 900° C. |
| NiCr8020 | 2.4869 | 19-21 | >75 | <1.0 | <0.3 | 0.5-2.0 | <1.0 | <0.15 | <0.5 | <0.020 | <0.015 | 1.12 (1.08) | 1.14 |
| NiCr7030 | 2.4658 | 29-32 | >60 | <5.0 | <0.3 | 0.5-2.0 | <1.0 | <0.10 | <0.5 | <0.020 | <0.015 | 1.19 (1.16) | 1.24 |
| NiCr6015 | 2.4867 | 14-19 | >59 | 18-25 | <0.3 | 0.5-2.0 | <2.0 | <0.15 | <0.5 | <0.020 | <0.015 | 1.13 (1.11) | 1.23 |
| NiCr3020 | 1.4860 | 20-22 | 28.0-31.0 | Remainder | | 2.0-3.0 | <1.5 | <0.2 | | <0.045 | <0.03 | 1.02 | 1.28 |
| NiCr2520 | 1.4843 | 22-25 | 19.0-22.0 | Remainder | | 1.5-2.5 | <2.0 | <0.2 | | <0.045 | <0.03 | 0.95 | 1.24 |

*) max. Co 1.5%

TABLE 2
Alloys according to ASTM B 344-01. All figures in wt. %

| | Cr | Ni + Co *) | Fe | Si | Mn | c | S | ρ(μΩm) | ct (at 871° C.) |
|---|---|---|---|---|---|---|---|---|---|
| 80Ni, 20Cr | 19-21 | Remainder | <1.0 | 0.75-1.75 | <1.0 | <0.15 | <0.01 | 1.081 | 1.008 |
| 60Ni, 16Cr | 14-18 | >57 | | 0.75-1.75 | <1.0 | <0.15 | <0.01 | 1.122 | 1.073 |
| 35Ni, 20Cr | 18-21 | 34-37 | Remainder | 1.0-3.0 | <1.0 | <0.15 | <0.01 | 1.014 | 1.214 |

TABLE 3
Commercially available alloys. All information in wt. %

| | | 14862 | | | 14862 | 14862 | |
|---|---|---|---|---|---|---|---|
| | | Nicrofer | | | Nicrofer | Nicrofer | |
| | | 3718- | Inconel | Bright | 3718So- | 3718So- | Nicrofer |
| | 353 Ma | Alloy330-DB | 330 | Alloy 35 | AlloyDS-DB | AlloyDS-Band | 3519Nb |
| Ni | 35 | 33-37 | 34-37 | 34-37 | 34.5-41 | 35-39 | 35.2-35.8 |
| Cr | 25 | 15-17 | 17-20 | 18-21 | 17-19 | 17-19 | 19.2-19.8 |
| Si | 1.3 | 1.-2 | 0.75-1.5 | 1.0-3.0 | 1.9-2.6 | 1.9-2.5 | 1.9-2.5 |
| Al | | | Max 2 | | | | |
| Mn | | Max 2 | | Max 1 | 0.8-1.5 | 0.8-1.5 | 1.5 |
| Nb | | | | | | | 0.9 |
| Cu | | | | | Max 0.5 | Max 0.5 | |
| Ti | | Max 0.2 | | | Max 0.2 | Max 0.2 | 1.5 |
| SE | | | | Yes | | | 0.03 |
| Ce | Yes | | | | | | |
| N | 0.17 | | | | | | |
| C | Max 0.05 | Max 0.15 | Max 0.08 | | Max 0.10 | Max 0.10 | |
| S | | Max 0.015 | Max 0.03 | Max 0.15 | Max 0.03 | | |
| P | | Max 0.045 | Max 0.03 | Max 0.01 | Max 0.03 | | |
| B | | | | | | | |
| Fe | Remainder | Remainder | Remainder | | Remainder | Remainder | Remainder |
| | | | | 24889 | | | |
| | Cronifer | Cronifer | Cronifer | Nicrofer | Nicrothal | WO2005/ | WO2005/ |
| | II | III | 45 | 45TM | 40 | 031018 A8 | 031018 A9 |
| Ni | 57-59 | 30-32 | 45-48 | 45-50 | 37 | 39-41 | 44-46 |
| Cr | 14-17 | 19.5-21.5 | 22-24 | 26-29 | 20 | 20-22 | 20-22 |
| Si | 1.0-1.75 | 1.8-3 | 1.5-2.2 | 2.5-3 | 2 | 1.6-1.5 | 1.0-1.5 |
| Al | Max 0.3 | Max 0.3 | Max 0.3 | Max 0.2 | | | |
| Mn | | Max 1.0 | Max 1.0 | Max 1 | | | |
| Nb | | | | | | | |
| Cu | | | | Max 0.3 | | | |
| Ti | | | | | | | |
| SE | Max 0.04 | Max 0.10 | Max 0.04 | 0.05-0.15 | | | |
| Ce | | | | | | 0.01-0.04 | 0.01-0.04 |
| N | | | | 0.17 | | Max 0.15 | Max 0.15 |
| C | | Max 0.01 | Max 0.08 | 0.05-0.12 | | Max 0.10 | Max 0.10 |
| S | | | | Max 0.01 | | | |
| P | | | | Max 0.015 | | | |
| B | | | | | | | |
| Fe | Remainder | Remainder | Remainder | Remainder | Remainder | Remainder | Remainder |

1-62. (canceled)

63. Iron-nickel-chromium-silicon-alloy, comprising in weight percent:
57−65% Ni,
12−26% Cr,
1.0−1.5% Si,
>0.1−0.7% Al,
0.1−0.7% Mn,
0.02−0.2% La,
0.001−0.05% Mg,
0.04−0.1% C,
0.02−0.1% N,
0.0005−0.05% Ca,
0.005−0.02% P,
max. 0.005% S,
max. 0.003% B,
at least one of the elements Ce, Y, Zr, Hf, Ti, each in a content of 0.01-0.3% and wherein the sum PwE=1.43·X_{Ce}+1.49·X_{La}+2.25·X_{Y}+2.19·X_{Zr}+1.12·X_{Hf}+4.18·X_{Ti} is ≦0.38, PwE being the potential of the effective elements listed in the equation, and wherein X is the content of the element specified by the subscript in weight percent, and
balance Fe and usual process-related impurities.

64. Alloy according to claim 63, wherein the Ni-content is 57-61% by weight.

65. Alloy according to claim 63, wherein the Ni-content is 61-65% by weight.

66. Alloy according to claim 63, wherein the Cr content is 14-18% by weight.

67. Alloy according to claim 63, wherein the Cr content is 18-21% by weight.

68. Alloy according to claim 63, wherein the Cr content is 20-26% by weight.

69. Alloy according to claim 63, wherein the Cr content is 21-24% by weight.

70. Alloy according to claim 63, wherein the Cr content is 20-23% by weight.

71. Alloy according to claim 63, wherein the Cr content is 23-26% by weight.

72. Alloy according to claim 63, wherein the La content is 0.02-0.15% by weight.

73. Alloy according to claim 63, wherein the La content is 0.04-0.15% by weight.

74. Alloy according to claim 63, wherein the N content is 0.03-0.09% by weight.

75. Alloy according to claim 63, wherein the N content is 0.05-0.09% by weight.

76. Alloy according to claim 63, wherein the Mg content is 0.008-0.05% by weight.

77. Alloy according to claim 63, wherein the Ca content is 0.001-0.05% by weight.

78. Alloy according to claim 63, wherein the Ca content is 0.01-0.05% by weight.

79. Alloy according to claim 63, comprising at least one of the elements Ce, Y, Zr, Hf, Ti, each in a content of 0.01-0.2% by weight and the sum PwE≦0.36.

80. Alloy according to claim 63, wherein the content of La is 0.02 to 0.15% by weight, further comprising at least one of the elements Ce, Y, Zr, Hf, Ti, each in a content of 0.02 to 0.15% by weight and wherein the sum PwE≦0.36.

81. Alloy according to claim 63, further comprising at least one of the elements Mo, W, V, Nb, Ta, Co, each in a content of 0.01 to 1.0% by weight.

82. Alloy according to claim 63, further comprising at least one of the elements Mo, W, V, Nb, Ta, Co, each in a content of 0.01 to 0.2% by weight.

83. Alloy according to claim 63, further comprising at least one of the elements Mo, W, V, Nb, Ta, Co, each in a content of 0.01 to 0.06% by weight.

84. Alloy according to claim 63, wherein the impurities comprise max. 1.0% Cu, max. 0.002% Pb, max. 0.002% Zn, max. 0.002% Sn.

85. An electrical heating element, comprising the alloy of claim 63.

86. A tubular heating element, comprising the alloy of claim 63.

87. The electrical heating element of claim 85 having the following properties: high shape stability and low sagging when operated.

88. A furnace, comprising the alloy of claim 63.
